(19) United States
(12) Patent Application Publication
(10) Pub. No.: US 2012/0021224 A1
(43) Pub. Date: Jan. 26, 2012

(54) GRAPHENE/GRAPHENE OXIDE PLATELET COMPOSITE MEMBRANES AND METHODS AND DEVICES THEREOF

(75) Inventors: William Neil Everett, Cedar Park, TX (US); William Martin Lackowski, Austin, TX (US); Joseph F. Pinkerton, Austin, TX (US)

(73) Assignee: CLEAN ENERGY LABS, LLC, Austin, TX (US)

(21) Appl. No.: 13/152,122

(22) Filed: Jun. 2, 2011

Related U.S. Application Data
(60) Provisional application No. 61/367,046, filed on Jul. 23, 2010.

(51) Int. Cl. B05D 5/12; B05D 3/02; B44C 1/175; B32B 9/00; B05D 3/10; B32B 37/00; B82Y 30/00; B82Y 40/00

(52) U.S. Cl. 428/408; 427/372.2; 427/343; 427/140; 156/60; 156/237; 427/97.6; 977/890; 977/734

(57) ABSTRACT

Methods for making composite membranes (graphene/graphene oxide platelet composite membranes) and methods of aligned transfer of such composite membranes to substrates are shown. Compositions and devices that include such composite membranes are further shown.

### CROSS-REFERENCE TO RELATED PATENT APPLICATIONS

This application claims priority to: provisional U.S. Patent Application Ser. No. 61/367,046, filed on Jul. 23, 2010, entitled “Methods For Aligned Transfer Of Thin Membranes To Substrates,” which provisional patent application is commonly assigned to the Assignee of the present invention and is hereby incorporated herein by reference in its entirety for all purposes.

### TECHNICAL FIELD

The present invention relates to composite membranes (graphene/graphene oxide platelet composite membranes) and methods of transfer of such composite membranes to substrates. The present invention further relates to compositions and devices that include such composite membranes.

### BACKGROUND

Graphene sheets—one-atom-thick two-dimensional layers of sp²-bonded carbon—have a range of unique electrical, thermal and mechanical properties. Just as glass windows are supported on all sides by a stronger structure (such as a wall), a “graphene window” is graphene supported on all sides by a much thicker material (typically metal). Graphene windows can be any shape, such as a round shape like a drum. The graphene of a graphene window generally is grown on its supporting metal (such as Cu).

Graphene membranes (also otherwise referred to as “graphene drums”) have been manufactured using process such as disclosed in Lee et al. Science, 2008, 321, 385-388. PCT Patent Appl. No. PCT/US09/59266 (Pinkerton) (the “PCT US09/59266 Application”) described tunneling current switch assemblies having graphene drums (which graphene drums generally having a diameter between about 500 nm and about 1500 nm). U.S. Patent Application Nos. 61/391,727 (Pinkerton et al.) and 61/427,011 (Everett et al.) further describe switch assemblies having graphene drums. A switch that includes a graphene membrane is a graphene membrane switch. (Again, like graphene windows, a graphene membrane can be any geometric shape).

As noted above, graphene sheets have a range of unique physical properties. For example, their thermal conductivity and mechanical stiffness rival the in-plane values for graphite; their fracture strength can be comparable to that of carbon nanotubes; and studies have shown that individual graphene sheets have extraordinary electronic transport properties. By incorporating graphene into a composite material, its properties can be utilized for various applications. S. Stankovich, et al., Nature 442, 282-286 (2006) disclose a general approach for the preparation of graphene-polymer composite via complete exfoliation of graphite and molecular-level dispersion of individual, chemically modified graphene sheets within polymer hosts.

Interest also exists regarding graphene-oxide materials. Graphene-oxide (GO) is a carbon-based nanomaterial with its own unique properties (and which can be readily dispersed in solvents). Moreover, control of the level of oxidation can adjust these properties, such as, for instance, the adjustment of opto-electronic properties. Such tunability allows for more desirable electronic properties (including the band gap) for required device performance. Furthermore, graphene-oxide provides an alternative path to potentially obtain pure graphene. K. A. Mkhoyan, et al., Nano Lett., 9(3), 1058-1063 (2009) discusses the atomic and electronic structure of graphene oxide.

G. Eda, et al. Nature Nanotechnology, 3, 270-274 (2008) (“Eda 2008”) reported large-area ultrathin films of reduced graphene oxide as transparent and flexible electronic materials and reported a flexible reduced graphene oxide transistor. Eda 2008 taught a solution-based method that allowed uniform and controllable deposition of reduced graphene oxide thin films with thicknesses ranging from a single monolayer to several layers over large areas. The opto-electronic properties could be tuned over several orders of magnitude, making them potentially useful for flexible and transparent semiconductors or semi-metals. The thinnest films made exhibited graphene-like ambipolar transistor characteristics, whereas the thicker films behaved as graphite-like semi-metals.

X. Wu, et al., Phys. Rev. Lett 101(2) 026801 (2008) (“Wu 2008”), disclosed a process to make an epitaxial-graphene/graphene-oxide junction from a continuous epitaxial film. To make this epitaxial-graphene/graphene-oxide junction, the epitaxial graphene was patterned into 3 μm wide ribbons with electrical leads using e-beam lithography. An e-beam resist was then spun on the sample. E-beam patterning was used to open windows oln the epitaxial-graphene ribbon. The epitaxial ribbon was then chemically oxidized using Hummers' method, in which the epitaxial graphene was converted into graphene oxide, while the epitaxial graphene still covered with resist on the ribbon remained protected from chemical reactions. The resultant structure was an epitaxial graphene/graphene oxide/epitaxial graphene junction. [Wu 2008].

W. Park proposed a graphene/oxide semiconductor (SnO₂, ZnO, In—Ga—Zn—O) for transparent thin film transistors. Such proposal can be found in the presentation found at http://phys570x.wikispaces.com/file/view/Proposal+presentation+by+Wonjun.pdf and at http://phys570x.wikispaces.com/file/view/Abstract+of+proposal+by+Wonjun+Park.pdf (collectively “Park”).

This device structure included: (a) a substrate (such as a transparent substrate with a back-gate (such as glass/ITO); (b) a gate insulator (such as SiO₂ or Al₂O₃); (c) channel material (such as solution-processed ZnO and graphene oxide); and (d) a gate (such as transparent electrode). Park's proposed synthesis of the graphene semiconductor composite was to form a preparation of ZnO sol via a sol gel method and combine with graphene oxide flakes made using Hummers' method. This mixture was reduced with hydrazine and heat treatment to form the reduced graphene oxide/ZnO composite.

### SUMMARY OF THE INVENTION

The present invention relates to methods for producing graphene/graphene oxide platelet composite thin films and compositions thereof.

In general, in one aspect, the invention features a method that includes selecting a growth substrate having a growth substrate surface. The method further includes growing graphene on the growth substrate surface. The graphene has a graphene surface. The method further includes applying a dispersion of graphene oxide platelets on the graphene surface. The method further includes producing a graphene/graphene oxide platelet composite membrane by forming a self-assembled film of graphene oxide platelets on the graphene. The step of forming the self-assembled film of graphene oxide sheets on the graphene includes drying the dispersion of graphene oxide platelets.

Implementations of the invention can include one or more of the following features:

The step of producing the graphene/graphene oxide platelet composite membrane can further include reducing the graphene oxide platelets of the self-assembled film of graphene oxide platelets on the graphene.

The growth substrate can be a metal foil or a metal film on a solid support.

The metal of the metal foil or the metal film can be Cu, Ni, and a combination thereof.

The growth substrate can include SiC.

The growth substrate can be a SiC single-crystal wafer.

The method can further include placing the growth substrate in a reactor chamber before the step of growing the graphene.

The step of growing the graphene can include a deposition process.

The step of growing the graphene can include a surface enrichment by selective elemental desorption.

The reduction of the graphene oxide platelets on the graphene can include exposure of the graphene oxide to methane.

The method can further include repairing structural defects when producing the graphene/graphene oxide platelet composite membrane.

The step of repairing defects can include exposing the graphene oxide to methane.

The method can further include repairing defects when producing the graphene/graphene oxide platelet composite membrane. The step of repairing defects can include exposing the graphene oxide to methane. The step of exposing the graphene oxide to methane can occur during the step of reducing the graphene oxide sheets on the graphene when forming the graphene/reduced graphene oxide platelet composite membrane.

The method can further include removing the graphene/graphene oxide platelet composite membrane from the growth substrate.

The method can further include transferring the graphene/graphene oxide platelet composite membrane to a second substrate.

The graphene/graphene oxide platelet composite membrane removed from the growth substrate can have a backing material that supports the graphene/graphene oxide platelet composite membrane during the step of transferring the graphene/graphene oxide platelet composite membrane to the second substrate.

The backing material can be a polymer, a metallic film, or a combination thereof.

The backing material can include a polymer that is PMMA, photoresist, wax, or a combination thereof.

The backing material can be removed after the step of transferring the graphene/graphene oxide platelet composite membrane to the second substrate.

The second substrate can include patterned features.

The patterned features can be topographical, electronic, or chemical in nature and combinations thereof.

The second substrate can include an electronic chip.

In general, in another aspect, the invention features a method that includes selecting a growth substrate having a growth substrate surface. The method further includes growing a conductive thin film on the growth substrate surface. The conductive thin film has a conductive thin film surface. The method further includes applying a dispersion of graphene oxide platelets on the conductive thin film surface. The method further includes producing a conductive thin film/graphene oxide platelet composite membrane by forming a self-assembled film of graphene oxide platelets on the conductive thin film. The step of forming the self-assembled film of graphene oxide platelets on the conductive thin film includes drying the dispersion of graphene oxide platelets.

Implementations of the invention can include one or more of the following features:

The step of producing the conductive thin film/graphene oxide platelet composite membrane can further include reducing the graphene oxide platelets on the conductive thin film.

The conductive thin film can include carbon nanotubes.

In general, in another aspect, the invention features a method that includes selecting a growth substrate having a growth substrate surface. The method further includes growing graphene on the growth substrate surface. The method further includes depositing a dispersion of graphene oxide on a second substrate. The graphene oxide has a graphene oxide surface. The method further includes transferring the graphene from the growth substrate onto the graphene oxide surface. The method further includes producing a graphene/graphene oxide platelet composite membrane from the graphene oxide and the graphene transferred from the growth substrate.

Implementations of the invention can include one or more of the following features:

The graphene oxide can be reduced before transferring the graphene onto the graphene oxide surface.

In general, in another aspect, the invention features a method that includes selecting a substrate having a substrate surface. The method further includes causing graphene to be on the substrate surface. The graphene has a graphene surface. The method further includes applying graphene oxide on the graphene surface. The method further includes forming a graphene/graphene oxide composite from the graphene and the graphene oxide.

In general, in another aspect, the invention features a method that includes forming a thin film of graphene. The graphene has a graphene surface. The method further includes applying a dispersion of graphene oxide platelets on the graphene surface. The method further includes producing a graphene/graphene oxide platelet composite membrane by forming a self-assembled film of graphene oxide platelets on the graphene. The step of forming the self-assembled film of graphene oxide sheets on the graphene includes drying the dispersion of graphene oxide platelets.

In general, in another aspect, the invention features a composition that includes a graphene/graphene oxide platelet composite membrane. The graphene/graphene oxide platelet composite membrane has a first thin film that includes graphene. The graphene/graphene oxide platelet composite membrane has a second thin film that includes a self-assembled film of graphene oxide platelets. The first thin film is on the second thin film.

Implementations of the invention can include one or more of the following features:

The graphene/graphene oxide platelet composite membrane can be a graphene/reduced graphene oxide platelet composite membrane.

The composition can further include a substrate having a surface. The graphene/graphene oxide platelet composite membrane can be on the surface of the substrate.

The graphene/graphene oxide platelet composite membrane can be removable from the substrate.

The graphene/graphene oxide platelet composite membrane can be a graphene/reduced graphene oxide platelet composite membrane.

In general, in another aspect, the invention features a device that includes a graphene/graphene oxide platelet composite membrane. The device further include a first substrate. The graphene/graphene oxide platelet composite membrane is on the first substrate.

Implementations of the invention can include one or more of the following features:

The graphene/graphene oxide platelet composite membrane can be made by the process that includes selecting a growth substrate having a growth substrate surface. The process can further include growing graphene on the growth substrate surface. The graphene can have a graphene surface. The process can further include applying a dispersion of graphene oxide platelets on the graphene surface. The process can further include producing the graphene/graphene oxide platelet composite membrane by forming a self-assembled film of graphene oxide platelets on the graphene. The step of forming the self-assembled film of graphene oxide platelets on the graphene can include drying the dispersion of graphene oxide platelets. The process can further include transferring the graphene/graphene oxide platelet composite membrane onto the first substrate.

The graphene/graphene oxide platelet composite membrane can further be made by the process of reducing the graphene oxide platelets on the graphene when forming the graphene/graphene oxide platelet composite membrane.

The can be a NEM device that is operable for utilizing the graphene/graphene oxide composite.

The device can be a graphene/graphene oxide membrane switch.

The device can be a graphene/graphene oxide membrane pump.

The first substrate can include an electronic chip.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### DESCRIPTION OF DRAWINGS

FIGS. 1A-1H shows a schematic illustrating a process to make a graphene/graphene oxide platelet composite membrane.

FIG. 2 is an SEM image that shows the graphene/graphene oxide platelet composite membrane placed over a metal-oxide chip.

FIG. 3 is another SEM image that shows the graphene/graphene oxide platelet composite membrane placed over a metal-oxide chip.

FIGS. 4A-4I shows a schematic illustrating an alternative process to make a graphene/graphene oxide platelet composite membrane.

### DETAILED DESCRIPTION

The present invention relates to methods for producing graphene/graphene oxide platelet composite membranes and compositions thereof. This thin film composite material of graphene and graphene oxide can then be transferred onto another surface to take advantage of the properties of the graphene and graphene oxide. By forming this composite, benefits are obtained due to the different properties of each constituent within the composite material. For instance, exfoliated HOPG graphene has excellent electrical and mechanical properties; however it generally suffers from inherent, and seemingly unavoidable, defects that impede scalability to production levels. The graphene and graphene oxide composite affords an easy and robust route to “repair” or “patch up” the defects in the graphene without significantly comprising the ultrathin quality of the graphene.

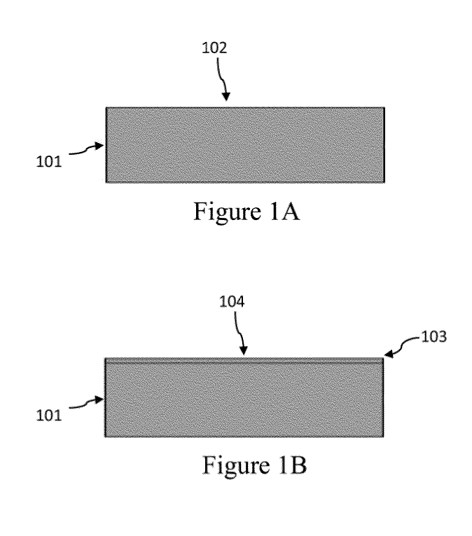

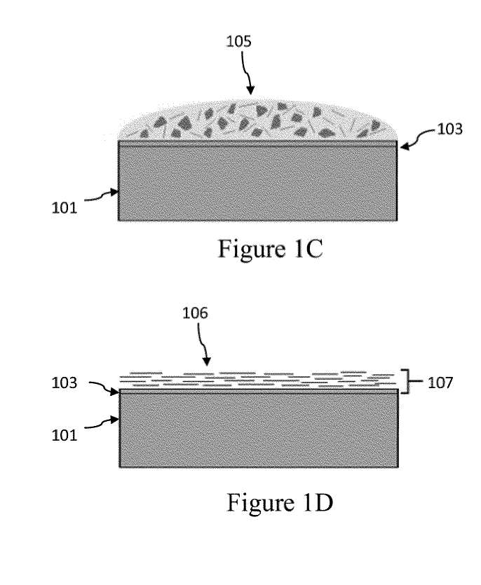

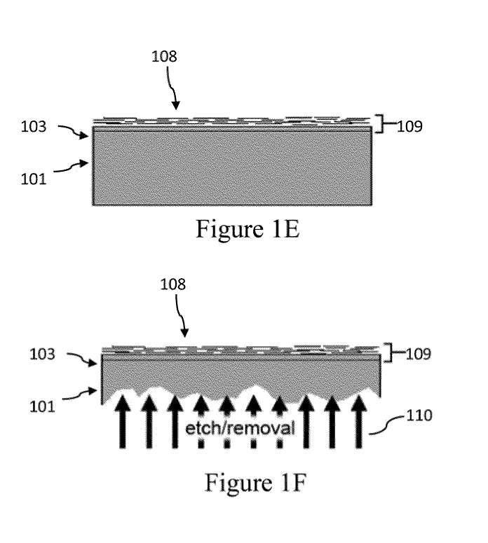

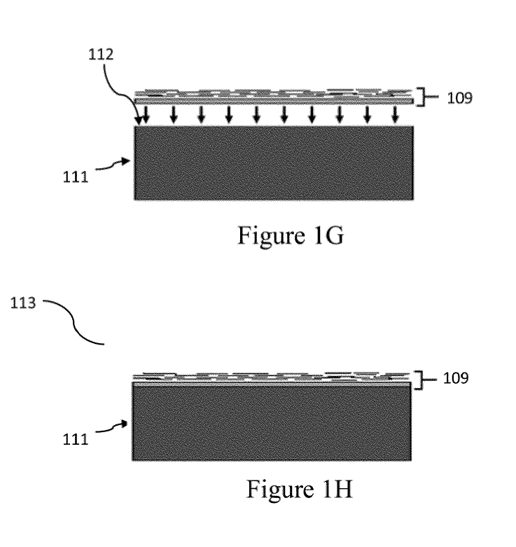

FIGS. 1A-1H show an embodiment of the present invention and illustrate a process to make a graphene/graphene oxide platelet composite membrane.

In FIG. 1A, a clean growth substrate 101 is shown. Growth substrate 101 can be a foil (such as Cu foil or a Ni foil) or a film on a solid support (such as Cu film on a solid support or Ni film on a solid support). In other embodiments of the invention, growth substrate 101 can be a SiC single crystal wafer. The growth substrate 101 is placed in a reactor chamber. Growth substrate 101 has a growth substrate surface 102.

As shown in FIG. 1B, graphene 103 (or alternatively another conductive thin film, such as carbon nanotubes) is grown on the growth substrate surface 102. Such growth can be performed by a depoSition method, such as through chemical vapor deposition. For instance, the chemical vapor deposition can be exposure of the growth substrate to a mixture of CH₄ and H₂ in the temperature range of 600 to 1000° C. [X. S. Li, et al., Science, 324:5932, 1312-1314 (2009)]. Alternatively, other growth methods known in the art can be utilized, including desorption of Si from SiC single-crystal surfaces to produce graphene [C. Berger, et al., Science, 312:5777, 1191-1196 (2006)] and surface precipitation of carbon into a graphene crystalline lattice from transition metals such as Ru [P. W. Sutter, Nature Materials, 7:5, 406-411, (2008)] or Ni [Q. K. Yu, et al., Applied Physics Letters, 93:11, 113103 (2008)]. The graphene 103 has a graphene surface 104.

As shown in FIG. 1C, a dispersion of graphene oxide platelets 105 is applied to the graphene surface 104.

As shown in FIG. 1D, the dispersion of graphene oxide sheets 105 is dried (such as through evaporation or spin coating) forming a self-assembled film 107 of graphene oxide sheets 106 atop the graphene 103. Self-assembled film 107 is a “graphene/graphene oxide platelet composite membrane” in that it is a composite membrane of a thin film of graphene and a self-assembled thin film of graphene oxide platelets (also termed “sheets”).

As shown in FIG. 1E, the self-assembled film 107 is chemically reduced (such as by exposure to (i) H₂ in the temperature range of 500-1000° C., (ii) a mixture of H₂ and supporting gases such as CH₄ and Ar (or another inert gas) in the temperature range of 500-1000° C., (iii) to hydrazine vapor, (iv) to L-ascorbic acid (vitamin C), or (v) by other reducing methods known in the art) to produce a graphene/reduced graphene oxide (“rGO”) composite 109. The graphene/graphene oxide composite 109 includes reduced graphene oxide 108 and graphene 103. The graphene/graphene oxide composite 109 is also a “graphene/graphene oxide platelet composite membrane,” and more particularly is a “graphene/reduced graphene oxide platelet composite membrane.”

In some embodiments, the reduction step includes exposure of the graphene oxide to methane, such as in a furnace and to serve as a supplement to the reduction process. It has been found that, in some embodiment, this addition of methane at elevated temperature improved the quality of the composite. It is believed that methane is not itself acting as a reduction agent, but rather believed that the methane gas is acting as a source of carbon atoms to repair some of the atomic defects that otherwise would have been present in the composite.

As shown in FIG. 1F, the graphene/graphene oxide platelet composite 109 that can then be removed from the growth substrate 101, such as via an etching process 110. The etching process can include: (i) uniform etching of the growth substrate from the backside with a chemical etchant (e.g., FeCl₃ for Cu), where the etch rate can be controlled by temperature and etchant concentration; (ii) non-uniform etching, where the backside of the growth substrate can be modified with a patterned protective layer that allows for the etchant to selectively etch unprotected areas of the growth substrate to create a pattern in the growth substrate, with the etch rate being controlled by temperature and etchant concentration. Alternatively, this removal step can be done by other processes known in the art, including adhesion of the graphene/reduced graphene oxide composite to a flexible or rigid substrate to facilitate mechanical removal (peeling) of the composite off of the growth substrate, where adhesion could be created by chemical bonding through primary or secondary bonds, such as electrostatic bonding through electrostatic field-mediated attraction.

As shown in FIG. 1G, the graphene/graphene oxide composite 109 can then be transferred onto another substrate 111 (having a surface 112). The substrate may contain patterned features (topographical, electronic, or chemical in nature). For instance, the substrate could be a metal oxide chip, a flexible support for electronic applications, a surface requiring an electrostatic dissipation layer, an intermediate surface in the production of electronic components such as thin-film capacitors, an intermediate layer required for the production of electronic displays, a chemically patterned surface such as one used for sensor applications, or a topographically patterned surface that serves to create structures used, for example, to create thin-film mechanical resonators.

FIG. 1H, illustrates the assembly 113 (or device), which has the graphene/graphene oxide composite 109 on substrate Ill.

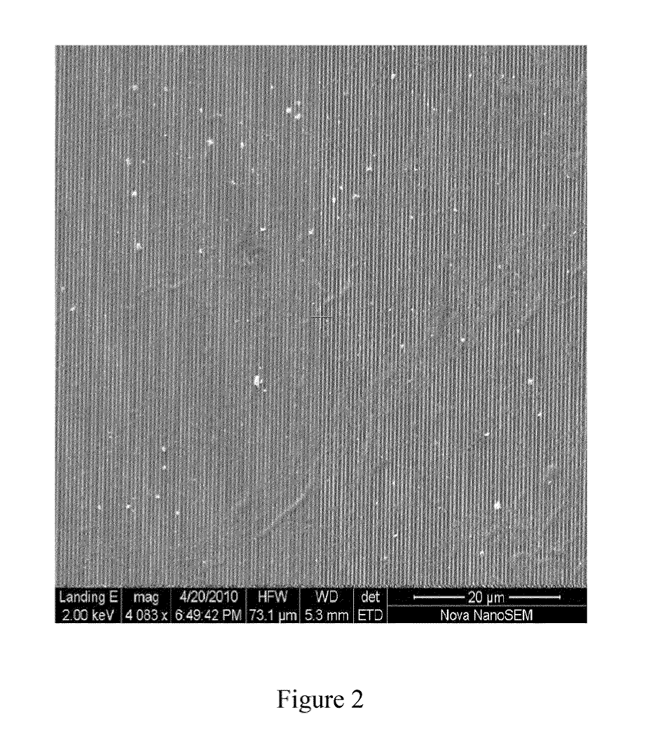

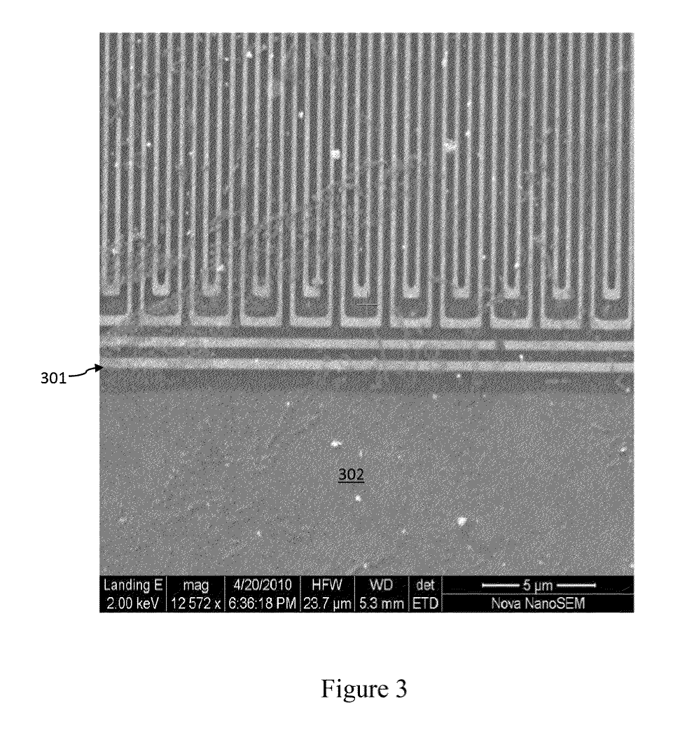

FIGS. 2-3 are SEM images that show the graphene/reduced graphene oxide composite placed over a metal-oxide chip. This graphene/reduced graphene oxide composite was made using the process discussed in FIGS. 1A-H, and includes a Si wafer with 200 nm-wide patterned tungsten traces (with a pitch ranging from 200 to 1200 nm) resting atop a 200 nm-thick thermal oxide insulating layer, with CVD graphene on Cu; a graphene oxide thin film made by spin coating graphene oxide platelets (dispersed in DI water) 15 times at 1500 rpm for 25 s followed by 2500 rpm for 5 seconds atop the CVD graphene on the Cu foil, which was then reduced in a H₂ and CH₃ gas mixture and separated from the Cu foil by removing the foil with FeCl₃ etch for 10 min.

FIG. 2 is a 4000× magnified SEM image that shows complete coverage of the graphene/graphene oxide material over a relatively large area of the metal-oxide chip.

FIG. 3 is a 12,500× magnified SEM image that shows the smooth transition of the graphene/graphene oxide material from an elevated horizontal trace to the flat substrate below (which looks like a shadow between the trace 301 and flat substrate 302).

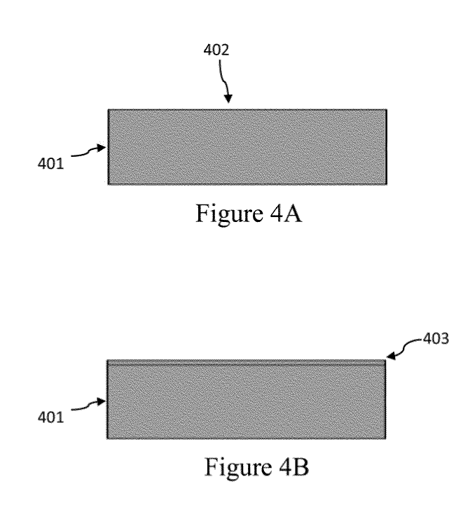

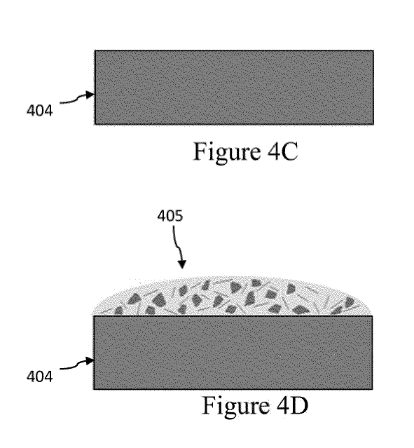

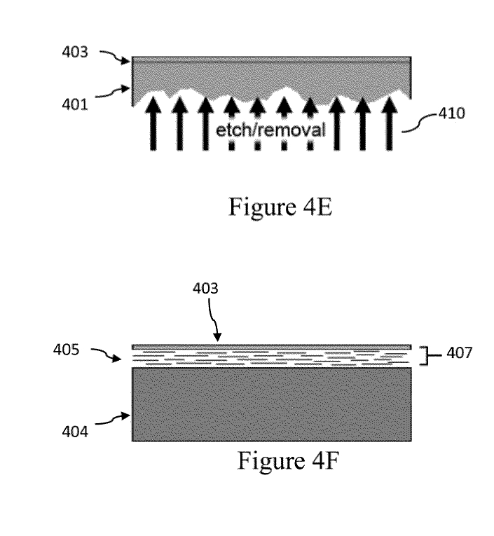

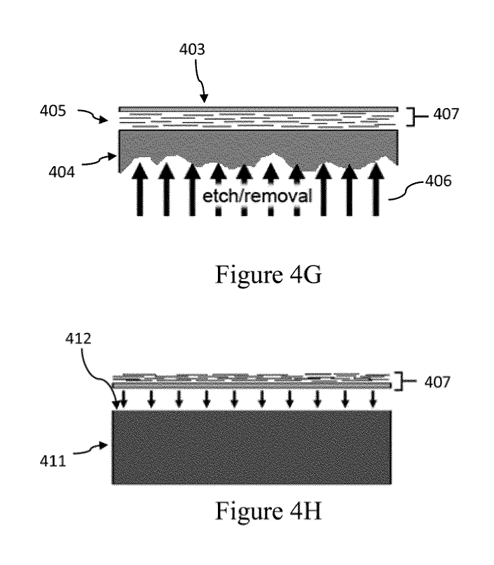

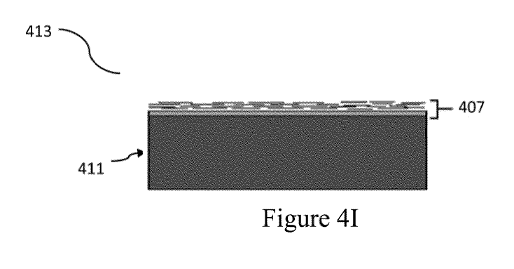

FIGS. 4A-4I shows a schematic illustrating an alternative process to make a graphene/graphene oxide platelet composite membrane. Similar to the process shown in FIGS. 1A-1B, the graphene 403 is grown on a growth substrate surface 402 of a growth substrate 401, such as shown in FIGS. 4A-4B. As shown in FIGS. 4C-4D, a dispersion of graphene oxide 405 is then deposited onto a second substrate 404 and dried to form a solid mass of graphene oxide platelets. As shown in FIG. 4E, the graphene 403 is then removed from the growth substrate 401 (such as via an etching process 410), and, as shown in FIG. 4F, transferred onto the graphene oxide 405 on the second substrate 404 to form the graphene/graphene oxide composite 407 Reduction of the graphene oxide can occur before or after the transfer of the graphene onto the graphene oxide. Preferably, such reduction would occur before such transfer.

This graphene/graphene oxide composite 407 can then, if desired, be transferred to a third substrate similar to the processes discussed above for FIGS. 1F-1H. As shown in FIG. 4G, the graphene/graphene oxide composite 407 can then be removed from the second substrate 404, such as via an etching process 406. As shown in FIG. 411, the graphene/graphene oxide composite 407 can then be transferred onto a third substrate 411 (having a surface 412). FIG. 41, illustrates the assembly 413 (or device), which has the graphene/graphene oxide composite 407 on third substrate 411.

Embodiments of the invention can be used in a variety of applications including, for example, electromechanical switches, conductive thin films for electronic displays, conductive thin film within electronic components such as capacitors, as a base layer for patterning conductive traces, as a thin film resonator for chemical or biochemical sensing applications, or for electro-dissipative coatings.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

What is claimed is:

1. A method comprising:
(i) selecting a growth substrate having a growth substrate surface;
(ii) growing graphene on the growth substrate surface, wherein the graphene has a graphene surface;
(iii) applying a dispersion of graphene oxide platelets on the graphene surface; and
(iv) producing a graphene/graphene oxide platelet composite membrane by forming a self-assembled film of graphene oxide platelets on the graphene, wherein the step of forming the self-assembled film of graphene oxide sheets on the graphene comprises drying the dispersion of graphene oxide platelets.

2. The method of claim 1, wherein the step of producing the graphene/graphene oxide platelet composite membrane further comprises reducing the graphene oxide platelets of the self-assembled film of graphene oxide platelets on the graphene.

3. The method of claim 1, wherein in the growth substrate is selected from the group consisting of a metal foil and a metal film on a solid support.

4. The method of claim 3, wherein metal of the metal foil or the metal film is selected from the group consisting of Cu, Ni, and combinations thereof.

5. The method of claim 1, wherein the growth substrate comprises SiC.

6. The method of claim 5, wherein the growth substrate is a SiC single-crystal wafer.

7. The method of claim 1 further comprising placing the growth substrate in a reactor chamber before the step of growing the graphene.

8. The method of claim 1, wherein the step of growing the graphene comprises a deposition process.

9. The method of claim 1, wherein the step of growing the graphene comprises a surface enrichment by selective elemental desorption.

10. The method of claim 2, wherein the reduction of the graphene oxide platelets on the graphene comprises exposure of the graphene oxide to methane.

11. The method of claim 1 further comprising repairing structural defects when producing the graphene/graphene oxide platelet composite membrane.

12. The method of claim 11, wherein the step of repairing defects comprises exposing the graphene oxide to methane.

13. The method of claim 2 further comprising repairing defects when producing the graphene/graphene oxide platelet composite membrane, wherein
(i) the step of repairing defects comprises exposing the graphene oxide to methane; and
(ii) the step of exposing the graphene oxide to methane occurs during the step of reducing the graphene oxide sheets on the graphene when forming the graphene/reduced graphene oxide platelet composite membrane.

14. The method of claim 1 further comprising removing the graphene/graphene oxide platelet composite membrane from the growth substrate.

15. The method of claim 14, further comprising transferring the graphene/graphene oxide platelet composite membrane to a second substrate.

16. The method of claim 15, wherein the graphene/graphene oxide platelet composite membrane removed from the growth substrate has a backing material that supports the graphene/graphene oxide platelet composite membrane during the step of transferring the graphene/graphene oxide platelet composite membrane to the second substrate.

17. The method of claim 16, wherein the backing material is selected from the group consisting of polymers, metallic films, and combinations thereof.

18. The method of claim 17, wherein the backing material comprises a polymer selected from the group consisting of PMMA, photoresist, wax, and combinations thereof.

19. The method of claim 16, wherein the backing material is removed after the step of transferring the graphene/graphene oxide platelet composite membrane to the second substrate.

20. The method of claim 15, wherein the second substrate comprises patterned features.

21. The method of claim 20, wherein the patterned features are selected from the group consisting of topographical, electronic, and chemical in nature and combinations thereof.

22. The method of claim 15, wherein the second substrate comprises an electronic chip.

23. A method comprising:
(i) selecting a growth substrate having a growth substrate surface;
(ii) growing a conductive thin film on the growth substrate surface, wherein the conductive thin film has a conductive thin film surface;
(iii) applying a dispersion of graphene oxide platelets on the conductive thin film surface;
(iv) producing a conductive thin film/graphene oxide platelet composite membrane by forming a self-assembled film of graphene oxide platelets on the conductive thin film, wherein the step of forming the self-assembled film of graphene oxide platelets on the conductive thin film comprises drying the dispersion of graphene oxide platelets.

24. The method of claim 23, wherein the step of producing the conductive thin film/graphene oxide platelet composite membrane further comprises reducing the graphene oxide platelets on the conductive thin film.

25. The method of claim 23, wherein the conductive thin film comprises carbon nanotubes.

26. A method comprising:
(i) selecting a growth substrate having a growth substrate surface;
(ii) growing graphene on the growth substrate surface;
(iii) depositing a dispersion of graphene oxide on a second substrate, wherein the graphene oxide has a graphene oxide surface;
(iv) transferring the graphene from the growth substrate onto the graphene oxide surface; and
(v) producing a graphene/graphene oxide platelet composite membrane from the graphene oxide and the graphene transferred from the growth substrate.

27. The method of claim 26, wherein the graphene oxide is reduced before transferring the graphene onto the graphene oxide surface.

28. A method comprising:
(i) selecting a substrate having a substrate surface;
(ii) causing graphene to be on the substrate surface, wherein the graphene has a graphene surface;
(iii) applying graphene oxide on the graphene surface;
(iv) forming a graphene/graphene oxide composite from the graphene and the graphene oxide.

29. A method comprising:
(i) forming a thin film of graphene, wherein the graphene has a graphene surface;
(ii) applying a dispersion of graphene oxide platelets on the graphene surface; and
(iii) producing a graphene/graphene oxide platelet composite membrane by forming a self-assembled film of graphene oxide platelets on the graphene, wherein the step of forming the self-assembled film of graphene oxide sheets on the graphene comprises drying the dispersion of graphene oxide platelets.

30. A composition comprising a graphene/graphene oxide platelet composite membrane, wherein
(i) the graphene/graphene oxide platelet composite membrane has a first thin film comprising graphene;
(ii) the graphene/graphene oxide platelet composite membrane has a second thin film comprising a self-assembled film of graphene oxide platelets; and
(iii) the first thin film is on the second thin film.

31. The composition of claim 30, wherein the graphene/graphene oxide platelet composite membrane is a graphene'reduced graphene oxide platelet composite membrane.

32. The composition of claim 30 further comprising a substrate having a surface, wherein the graphene/graphene oxide platelet composite membrane is on the surface of the substrate.

33. The composition of claim 32, wherein the graphene/graphene oxide platelet composite membrane is removable from the substrate.

34. The composition of claim 33, wherein the graphene/graphene oxide platelet composite membrane is a grapheneireduced graphene oxide platelet composite membrane.

35. A device comprising:
(i) a graphene/graphene oxide platelet composite membrane; and
(ii) a first substrate, wherein the graphene/graphene oxide platelet composite membrane is on the first substrate.

36. The device of claim 35, wherein the graphene/graphene oxide platelet composite membrane is made by the process comprising
(i) selecting a growth substrate having a growth substrate surface;
(ii) growing graphene on the growth substrate surface, wherein the graphene has a graphene surface;
(iii) applying a dispersion of graphene oxide platelets on the graphene surface;
(iv) producing the graphene/graphene oxide platelet composite membrane by forming a self-assembled film of graphene oxide platelets on the graphene, wherein the step of forming the self-assembled film of graphene oxide platelets on the graphene comprises drying the dispersion of graphene oxide platelets; and
(v) transferring the graphene/graphene oxide platelet composite membrane onto the first substrate.

37. The device of claim 36, wherein the graphene/graphene oxide platelet composite membrane is further made by the process of reducing the graphene oxide platelets on the graphene when forming the graphene/graphene oxide platelet composite membrane.

38. The device of claim 35, wherein the device is a NEM device that is operable for utilizing the graphene/graphene oxide composite.

39. The device of claim 35, wherein the device is a graphene/graphene oxide membrane switch.

40. The device of claim 35, wherein the device is a graphene/graphene oxide membrane pump.

41. The device of claim 35, wherein the first substrate comprises an electronic chip.
